(19) United States
(12) Patent Application Publication
(10) Pub. No.: US 2025/0335971 A1
(43) Pub. Date: Oct. 30, 2025

(54) CORRECTION OF FALSE ALARMS ASSOCIATED WITH FALSE DISTRESS ORDERS IN SUPPLY CHAIN SYSTEMS

(71) Applicant: Dell Products L.P., Round Rock, TX (US)

(72) Inventor: Shibi Panikkar, Bangalore (IN)

(21) Appl. No.: 18/644,429

(22) Filed: Apr. 24, 2024

(51) Int. Cl. G06Q 30/0601

(52) U.S. Cl. CPC G06Q 30/0635

(57) ABSTRACT

Correcting false alarms associated with false distress orders in supply chain systems is presented herein. An example method comprises receiving an active order for development of a service associated with a product, a service level agreement associated with the active order, and a status identifier appended to the active order, determining that the active order is a suspected false distress order, using a first model to determine that the suspected false distress order is a false distress order; and using a second model, the service level agreement appended to the active order, and the defined status identifier appended to the active order, to determine a predicted time value to enter in a record of records associated with the active order, wherein the predicted time value is a prediction supplied by the second model.

### BACKGROUND

The supply chains of large corporate business entities have become too complex due to the use of multiple external subsystems associated with third-party vendor entities, as well as complexities associated with a multitude of disparate internal information technology (IT) systems.

The above-described background relating to supply chains is merely intended to provide a contextual overview of some current issues and is not intended to be exhaustive. Other contextual information may become further apparent upon review of the following detailed description.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a system for correcting false alarms associated with false distress orders in supply chain systems, in accordance with various non-limiting example embodiments.

FIG. 2 depicts a block diagram of a system for correcting false alarms associated with false distress orders in supply chain systems, in accordance with various non-limiting example embodiments.

FIG. 3 illustrates another block diagram of a system for correcting false alarms associated with false distress orders in supply chain systems, in accordance with various non-limiting example embodiments.

FIG. 4 illustrates a time sequence chart or a method for correcting false alarms associated with false distress orders in supply chain systems, in accordance with various non-limiting example embodiments.

FIG. 5 illustrates yet a further flow chart or a method for correcting false alarms associated with false distress orders in supply chain systems, in accordance with various non-limiting example embodiments.

FIG. 6 depicts a further flow chart or a method for correcting false alarms associated with false distress orders in supply chain systems, in accordance with various non-limiting example embodiments.

FIG. 7 depicts a further flow chart or a method for correcting false alarms associated with false distress orders in supply chain systems, in accordance with various non-limiting example embodiments.

FIG. 8 illustrates a further flow chart or a method for correcting false alarms associated with false distress orders in supply chain systems, in accordance with various non-limiting example embodiments.

FIG. 9 depicts another flow chart or a method for correcting false alarms associated with false distress orders in supply chain systems, in accordance with various non-limiting example embodiments.

FIG. 10 illustrates yet another further flow chart or a method for correcting false alarms associated with false distress orders in supply chain systems, in accordance with various non-limiting example embodiments.

FIG. 11 depicts another flow chart or a method for correcting false alarms associated with false distress orders in supply chain systems, in accordance with various non-limiting example embodiments.

FIG. 12 illustrates a flow chart or a method for correcting false alarms associated with false distress orders in supply chain systems, in accordance with various non-limiting example embodiments.

FIG. 13 depicts a further flow chart or a method for correcting false alarms associated with false distress orders in supply chain systems, in accordance with various non-limiting example embodiments.

FIG. 14 provides illustration of a system for correcting false alarms associated with false distress orders in supply chain systems, in accordance with various non-limiting example embodiments.

FIG. 15 illustrates an elastic cloud storage (ECS) system, in accordance with various non-limiting example embodiments.

FIG. 16 illustrates a block diagram representing an illustrative non-limiting computing system or operating environment in which one or more aspects of various non-limiting embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

As mentioned in the background section, supply chains of large corporate business entities have become too complex. In this regard, concerning supply chain types of orders, wherein there is a subscription and an actual fulfillment and/or shipment of the product to the end user, these can add additional complexities to satisfactorily remedying the issue. Maintaining accuracy in order statuses can be a monumental task. Currently it would appear that there are no off the shelf solutions to track an order status accurately, and as such, most industry players have adopted ad hoc, bespoke, and customized solutions to track orders and maintain and ensure that respective order statuses remain accurate for the entirely of the supply chain (e.g., from when an end user orders or subscribes to a product until the ordered product is shipped and received by the end user).

In consideration of these and/or other drawbacks of conventional supply chain implementations, this disclosure is related to correcting false alarms associated with distress orders in corporate supply chain systems. As noted earlier, supply chains associated with large corporate business entities have over time become more unwieldy, cumbrous, and complex. In many instances the complexity can be attributed to the use of multiple external subsystems associated with subcontracting business entities, such as third party logistic partners (e.g., strategic business partners) to which component parts of a whole product and/or a whole solution are outsourced for production. For example, in the context of a multinational corporation that designs, manufactures, and sells airplanes, rockets, satellites, telecommunications equipment, and the like, worldwide, avionics systems associated with a developed aircraft, for instance, can be manufactured at a first subcontracting corporate entity, the wings and tail sections can be manufactured and assembled at a second subcontracting corporate entity, and the turbofan engines can be designed, manufactured, and/or tested for compliance with overall prescribed and agreed upon design and technical standards by a third subcontracting corporate organization. Further, additional complexity can be due to the cumbrous nature of internal information technology (IT) infrastructures, such as order booking systems, revenue systems, license management systems, and the like, that can he hosted, for example, by an internal IT communications infrastructure comprising a plethora of servers, databases of databases, processing resource equipment, and the like. Further, in connection with orders received from customers (and/or end user identities), and processed by the internal IT supply systems, deficiencies in the implementation of the order booking process and/or subscription process can provide added complexities. Thus, maintaining the accuracy of order statuses throughout the corporate entity's supply chain infrastructure can be a monumental task.

At the time of this disclosure, there do not appear to be satisfactory and viable solutions to the issue of accurately tracking order statuses throughout the extent of the corporate supply chain (e.g., from a customer initiating an order for a product and/or service to the ultimate shipment and delivery of the ordered product and/or service to the customer).

The disclosed systems and methods, in accordance with various embodiments, provide a system, apparatus, or device comprising: at least one processor; and at least one memory that stores executable instructions that, when executed by the processor, facilitate performance of operations. The operations can comprise: receiving, from a customer device associated with a customer identity, an active order for a manufacture of a product, based on the active order, a service level agreement associated with the active order, and a defined status identifier appended to the active order, determining that the active order is a suspected false distress order, based on the suspected false distress order, using a classification model to determine that the suspected false distress order is a false distress order, and based on determining that the suspected false distress order is the false distress order, using a regression model, the service level agreement appended to the active order, and the defined status identifier appended to the active order, to determine a predicted time value to enter in a record of records associated with the active order, wherein the predicted time value is a prediction, using the regression model, based on a dataset of historical time values associated with the defined status identifier and a previous active order associated with the defined status identifier.

Prior to the classification model being deployed the classification model can be trained based on a determined gradient boosting framework, initialized using a group of default parameters, and adapted using at least one of a collection of hyper-parameters comprising a number value of boosting stages to be executed in tuning the classification model, a learning rate representing a value at which the classification model adapts over each iteration of the classification model before deployment into a production environment, or a maximum depth value of individual estimators. Further, prior to deployment, the classification model can be evaluated using a validation dataset, wherein evaluation of a performance of the classification model can be based on a diversity of hyper-parameters. The classification model can also be evaluated using a testing dataset in relation to an accuracy of the classification model, a precision of the classification model, and a confusion matrix. Additionally, the classification model can be evaluated based on an analysis of feature importance, wherein the analysis of the feature importance indicates areas associated with the classification model prior to deployment of the classification model into a production environment to increase a defined performance metric associated with the production environment.

In accordance with further embodiments, the subject disclosure describes a method, comprising a sequence of acts that can include: in response to receiving, by a device comprising at least one processor, an active order for development of a service associated with a product, a service level agreement associated with the active order, and a defined status identifier appended to the active order, determining that the active order is a suspected false distress order, based on the suspected false distress order, using, by the device, a first model to determine that the suspected false distress order is a false distress order; and based on determining that the suspected false distress order is the false distress order, using, by the device, a second model, the service level agreement appended to the active order, and the defined status identifier appended to the active order, to determine a predicted time value to enter in a record of records associated with the active order, wherein the predicted time value is a prediction, by the second model, based on a dataset of historical time values associated with the defined status identifier and a previous active order associated with the defined status identifier.

The second model, before deployment of the second model into a production environment, can be developed based on a dataset that comprises previous active order data representing a group of previously active orders associated with a good order flag indicative that the previously active order was not marked as being the suspected false distress order, wherein the previous active order of the group of previously active orders comprises a grouping of features comprising order attributes and processing time values at one or more processing state associated with the defined status identifier appended to the previously active order.

The second model, before deployment of the second model into a production environment, can also be developed: using a target variable value representative of an actual time for the active order to transition from a first production state to a second production state, and/or by using a first time value associated with a placement, based on user input associated with a user entity, of a previously active order and a second time value associated with initiating, by the device, the service associated with the product, and the service level agreement associated with the initiating of the service associated with the product.

Additionally, the second model, before deployment of the second model into a production environment, can be initialized using a random forest regression process, and/or can be trained using a training dataset comprising a sub-grouping of previous active order data representing previously active orders associated with a good order flag indicative that a previously active order was not marked as being the suspected false distress order. The second model, before deployment of the second model into a production environment, can also be evaluated using a testing dataset comprising a sub-group of previously active order data representing previously active orders associated with a bona fide order flag indicative that the previously active order was not marked as being the suspected false distress order. Also, the second model, before deployment of the second model into a production environment, can be evaluated using a metric for regression comprising a mean absolute error metric, a mean squared error metric, or a root mean squared error metric.

In accordance with still further embodiments, the subject disclosure describes a machine-readable storage medium, a computer readable storage device, or non-transitory machine-readable media comprising instructions that, in response to execution, cause a computing system comprising at least one processor to perform operations. The operations can comprise: in response to receiving an active order for development of a service associated with a product, a service level agreement associated with the active order, and a defined status identifier appended to the active order, determining that the active order is a suspected false distress order, based on the suspected false distress order, using a first model to determine that the suspected false distress order is a false distress order; and based on identifying the false distress order, using a second model, the service level agreement appended to the active order, and the defined status identifier appended to the active order, to determine a predicted time value to enter in a record of records associated with the active order, wherein the predicted time value is a prediction, by the second model, based on a dataset of historical time values associated with the defined status identifier and a previous active order associated with the defined status identifier.

In regard to the foregoing, the first model prior to deployment can be adapted using a collection of hyper-parameters comprising a number value of boosting stages to be executed in tuning the first model, a learning rate representing a value at which the first model adapts over each iteration of the first model before the deployment into a production environment, and a maximum depth value of individual estimators. In addition, the first model, prior to deployment, can be evaluated using a validation dataset, wherein evaluation of performance of the first model prior to the deployment is based on a diversity corresponding to hyper-parameters applicable to the first model. Moreover, the first model can be evaluated using at least one of a testing dataset in relation to an accuracy of the first model, a precision of the first model, or a confusion matrix.

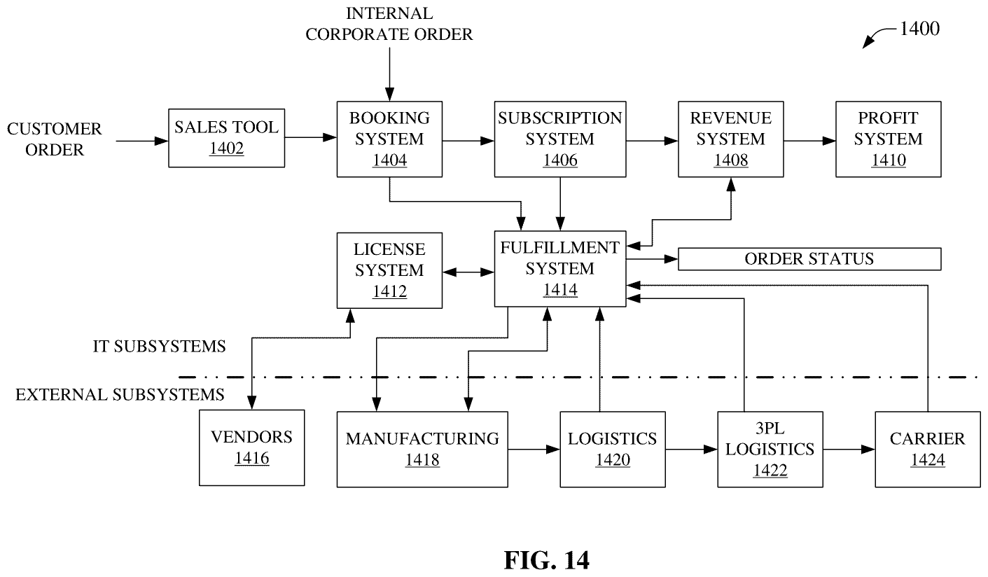

A typical ‘as a service order’ can comprise a subscription order (e.g., generally used when services are at the core of the order) and/or an internal manufacturing order (e.g., used typically when a product is to be manufactured). FIG. 14 provides a general non-limiting overview of a typical corporate IT infrastructure and the multitude of internal and external subsystem infrastructures that can be employed prior to an ordered product and/or an ordered service being fulfilled and ultimately dispatched and delivered to the ordering customer/end user.

In reference to FIG. 14, depicted is a system 1400 that can comprise a collection of internal IT subsystems and external subsystems. As illustrated the collection of internal IT subsystems (e.g., systems illustrated as being above the dotted line) can comprise a sales tool 1402 the can be used by a customer identity to order one or more product and/or one or more service from the corporate entity hosting the internal IT subsystems.

In response to receiving the one or more product order data and/or one or more service order data from a customer identity (e.g., via the sales tool 1402), the one or more product order data and/or one or more service order data can be sent to booking system 1404. Booking system 1404, if needed, can create subscription request data (e.g., for the customer identity ordered service(s) and/or for the customer identity ordered product(s)), and thereafter can forward the subscription request data to subscription system 1406. On receiving the subscription request data, subscription system 1406, using database equipment of a collection of database equipment, for example, can identify price values (pricing data) associated with the ordered product(s) and/or the ordered service(s), at which point the customer identity initiated order data together with the subscription request data and associated pricing data for the ordered products and/or ordered services can be conveyed/transmitted to revenue system 1408 and/or profit system 1410. In regard to revenue system 1408, this subsystem can receive subsequent input from fulfillment system 1414 regarding the costs associated with fulfilling the order in accordance with the customer's specifications. Revenue system 1408 can thereafter determine, based on one or more accounting standards (e.g., generally accepted accounting principles (GAAP)), revenue metrics data associated with fulfilling the order.

In regard to sales tool 1402 it should be noted that the sales tool functionality and/or facility can be performed using a bespoke web application (e.g., software in execution) that can be hosted on outward facing networking equipment that can isolate and provide a secure interface between the internal corporate IT infrastructure and the global Internet infrastructure in general. Typical outward facing internal corporate IT infrastructure equipment can include equipment that includes at least one processor. Additionally and/or alternatively, the outward facing equipment can be situated in a cloud based computing environment.

It should further be noted that orders for products and/or services can also be received, for instance, from user identities associated with the corporate entity that provides the commercial products and/or services that the corporate entity is selling. In this instance, such corporate entity user identities can circumvent the use of the sales tool 1402 and opt to directly initiate orders for products and/or services via booking system 1404, thereby sidestepping subscription system 1406, revenue system 1408, and/or profit system 1410. The rationale for the foregoing being that corporate entity user identities typically are not deemed as profit centers for the corporate entity, as the products and/or services generally will be supplied at cost or near cost.

Once an order for products and/or services has been received by booking system 1404, booking system 1404 can forward the order request to fulfillment system 1414, at which time (e.g., concurrently) fulfillment system 1414 can send a request to license system 1412 to obtain appropriate licenses (e.g., software licenses, hardware licenses, intellectual property licenses, and the like) and/or authorizations (e.g., governmental export licenses, authorizations for the export of restricted technologies, etc.) associated with the ordered products and/or services. Once the relevant licenses and/or authorizations have been obtained, license system 1412 can (i) return to fulfillment system 1414 status messages indicating that appropriate licenses and/or authorizations have been acquired; and/or (ii) transmit the order request to one or more vendor (e.g., external subcontractors) systems 1416, wherein the one or more vendor systems 1416 can facilitate production of the ordered products and/or initiate provision of the ordered services. It will be observed in the context of vendor systems 1416 that vendor systems 1416 can be in operative communication with licensing system 1412 to ensure that all licenses and/or all authorizations for the ordered products and/or services are maintained and kept up-to-date. Thus, as depicted, status message data can be communicated between vendor systems 1416 and license system 1412.

Further, concerning fulfillment system 1414, in response to receiving order requests for products and/or services from booking system 1404, fulfillment system 1414 can forward the order requests to manufacturing system 1418. It will be noted in regard to manufacturing system 1418 that there can be one or more manufacturing system 1418 associated with a multitude of subcontracting entities associated with the corporate entity through which the order requests for products and/or services emanate. For example, in relation to a primary corporate entity that is in the business of building and selling passenger aircraft, the plethora of manufacturing entities can include subcontracting corporate entities associated with the primary corporate entity. These subcontracting corporate entities can, for example, comprise a first manufacturing entity that can exclusively focus on designing and building commercial turbofan jet engines, and depending on customer preference, an alternative manufacturing entity that can also focus on designing and manufacturing commercial turbofan jet engines, a second manufacturing entity that can focus on constructing the empennage of the aircraft, a third manufacturing entity that can be responsible for providing avionics,

As depicted in FIG. 14, it will be observed that fulfillment system 1414 can be in operative and bidirectional communication with the one or more manufacturing system 1418. Thus, during the manufacturing process to complete order requests for products and/or services, fulfillment system 1414, for example, can transmit to manufacturing system 1418 any adjustments/updates in relation to the order requests for products and/or services. For instance, prior to the ordered product and/or service being completed by the manufacturing entity, the customer, for example, due to technical upgrades/revisions to the production of the ordered product and/or service, can request, via sales tool 1402, booking system 1404, and/or fulfillment system 1414, for instance, that the final product/service needs to be modified to incorporate enumerated technical revisions/upgrades.

Once the final product/service has been manufactured to specification, manufacturing system 1418 can, via advanced shipment notification data, notify fulfillment system 1414 that the final product/service has been sent to logistics system 1420. Logistics system 1420 can be associated, for example, with a shipping corporate entity, wherein the final product/service can be forwarded to the customer. Additionally and/or alternatively, the final product/service can nevertheless need to be shipped to a third party logistics (3PL) entity wherein additional components can be added. Thus, 3PL logistic system 1422 can receive notification data associated with the final product/service (or partially completed product/service). The final product/service (or partially completed product/service) can then be completed/finalized by the 3PL logistics corporate entity, wherein 3PL logistics system 1422 can notify fulfillment system 1414 and/or carrier system 1424. Carrier system 1424, in response to receiving the completed/finalized product/service can then send the completed/finalized product/service to the customer identity or end user identity. On dispatch of the completed/finalized product/service to the customer identity or end user identity, carrier system 1424 can send appropriate notification data indicating that the completed/finalized product/service has been sent and/or received by the customer identity or end user identity.

In regard to each of logistics system 1420, 3PL logistics system 1422, and/or carrier system 1424, each of these externally based subsystems can be associated with disparate corporate business enterprises and can transmit notification data, for example, to internally based fulfillment system 1414 in relation to their respective handling and processing of the finalized/completed product and/or service. For instance, once the corporate enterprise associated with logistic system 1420 has completed the work on the ordered product and/or service, logistic system 1420 can transmit message data to fulfillment system 1414 noting that it has completed its portion of the work on the ordered product/service. Similarly, once the respective corporate entities respectively responsible for 3PL logistics system 1422 and/or carrier system 1424 have completed their respective portions of the ordered product and/or service, they too can respectively report to fulfillment system 1414 that the contracted work on the ordered product/service has been completed. In regard to sending notifications from respective subsystems situated and depicted as being external subsystems, the notifications can also be transmitted back to fulfillment system 1414 when each of the respective externally based subsystems respectively receive the yet to be completed product/service.

In regard to vendor system 1416, manufacturing system 1418, logistics system 1420, 3PL logistics system 1422, and carrier system 1424, this group of systems can comprise external subsystems that generally are associated with independent corporate entities; these independent corporate entities typically do not fall within the business enterprise ambit of the corporate entity through which the order request was initiated.

It will have been observed from the foregoing that there can be many notifications (e.g., status messaging data) being sent, exchanged, communicated, and/or transmitted between the various subsystems, both internal and/or external, of the primary corporate entity (e.g., the corporate entity through which the initial order was placed using, for instance, sales tool 1402). These notifications can be used to track the progress of a customer order as it traverses through the system (e.g., system 1400 as illustrated in FIG. 14). Each business organization can have their own order status messaging paradigm as well as service level agreements (SLAs) associated with each order status.

In some organizations there can be several statuses, such as order booked (OB); pending production (PP) indicating that an order is yet to be scheduled to be forwarded to a manufacturing business entity (e.g., a business entity associated with manufacturing subsystem 1418); in production (IP) indicating that the order has reached the manufacturing business entity and is undergoing production; and shipment complete (SC) indicating that the product has either been shipped from the manufacturing business entity to the end user/customer, and/or the order has been sent to a merge center (e.g., a business entity that provides third party logistics, such as first business entities that provide components to be added to the manufactured product/service, and/or second business entities that can provide third party logistics (e.g., delivery to the end user/customer via a carrier—corporate entities that provide package and/or parcel delivery services). Other statuses can comprise manifest (MN)—an indication that the order is ready for accounting (e.g., processing by revenue system 1408 and/or profit system 1410); complete (CMP)—a status that indicates that the order has been completed; and subscription activated (SA)—a status the indicates that a service such as the activation of intellectual property licenses, the commencement of maintenance services for the completed order, etc.

Concerning the various statuses; each of the statuses can be associated with a defined SLA. For instance, when an order is associated with the PP status the defined SLA for this status can require that the order be processed with a two day (e.g., 48 hour) time window. Further, when an order is associated with an IP status the defined SLA associated with this status can mandate that the manufacturing process be complete within twelve days (e.g., within 288 hours). Thus, each status can be associated with a defined SLA, wherein each SLA can be associated with a defined or definable time value.

In regard to statuses, it should be noted that each status can be associated with one or more sub-status, wherein each sub-status can be associated with its own defined SLA. For example, a PP status can be associated with the following sub-statuses, such as: order routed sub-status, work order created sub-status, license obtained sub-status, governmental export authorization and/or approval sub-status, purchase order generated sub-status, order scheduled sub-status, and the like.

Generally, most orders will traverse through each stage of system 1400 in accordance with the statuses (or sub-statuses) assigned to each stage, and in accordance with the respective SLAs appended/associated with each respective stage (and sub-stage). Nevertheless, there can be a significant minority of production orders that, for various reasons, can be delayed. Orders that are delayed (e.g., the order at a particular stage in the process has exceeded the defined time thresholds set forth in the SLA) can be referred to as “distress orders”. When there are time delays that exceed the defined time threshold mandated in the SLA at issue, a subject matter engineer (SME) currently has to reactively and manually investigate each and every distress order to identify where the bottleneck in the production order has occurred. Investigation of production bottlenecks, determining reasons why a “distress order” occurred, and remedying the “distress orders” can be an extremely time intensive task for the SME.

There can be many occurrences of what can be referred to as “false negative” distress orders (e.g., instances where the status associated with the production order is not actually reflective of, and/or synchronized with, the true reality (e.g., status) as to where in the production process the production order has actually transitioned to. For example, should manufacturing system 1418, or 3PL logistics system 1422, fail to return “shipping notification” status data to fulfillment system 1414, or fulfillment system 1414, due to functional and/or infrastructure issues, has failed to update an order status in response to receiving status data associated with one or more order statuses allied with other disparate subsystems depicted as comprising system 1400, the production and delivery of the order to the eventual customer can nevertheless have already taken place.

In the foregoing instance, the order status, for example, can have been marked as being IP, wherein the IP status can have an associated an SLA requiring at the maximum of a 12 day (e.g., 288 hours) turnaround. The following illustrative issues can then arise: (i) very shortly after the elapse of the 12^{th} day (e.g., after 288.5 hours) the order can be assigned to an SME; (ii) the SME then needs to track the order back through the internal IT systems to determine where the problem occurred, and/or track forwarded to identify whether the order has been shipped or not, the SME then has the task to correct the status and release the order (e.g., link the correct status to the production order) for further processing by system 1400; (iii) as a consequence of (i) and (ii) the revenue system (e.g., revenue system 1408) can show erroneous values, as the booking system 1404 typically cannot book revenue at the appropriate time for the subscription system aspect (e.g., subscription system 1406) since the costs associated with manufacturing the product/service will generally only be received from the manufacturing system aspect (e.g., manufacturing system 1418) in response to the manufacture of the product/service having been indicated as being complete; and (iv) once the SME has remedied and/or rectified the apparent bottlenecks concerning the flow of status messages, there can still be an issue with regard to the actual times that the production order spent in each of the various downstream statuses (e.g., downstream subsystems) in accordance with respective SLAs.

It has been recognized that while internal IT subsystems and/or external subsystems can be distributed over wide geographical areas, there nonetheless can be a hierarchical relationship between the internal IT subsystems and external subsystems illustrated in FIG. 14 when a production order traverses through each of the depicted subsystems. This disclosure proposes to use the noted subsystem hierarchical inputs from the various subsystems together with artificial intelligence models to detect anomalies in the respective order statuses, and based on these detected anomalies to both rectify anomalies in the internal IT subsystems, remedy the order statuses, and, if necessary, when SME intervention is actually needed, to route to the SME, the fact that anomalies have been detected, probable causes for the detected anomalies, and/or possible remedial actions that can be performed by the SME in order to resolve the detected anomalies.

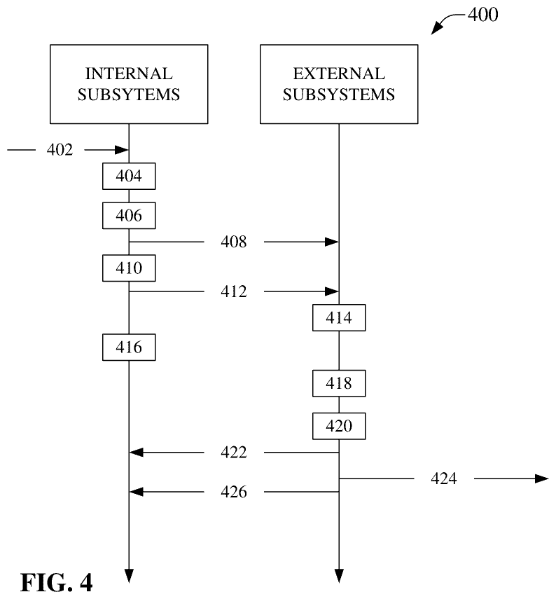

Concerning FIGS. 4-13 these illustrate flowcharts, time sequences, and/or methodologies for performing operations corresponding to system 100, system 200, and system 300 in accordance with various example embodiments. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies and/or time sequences in accordance with the disclosed subject matter. In addition, those skilled in the art will understand and appreciate that the time sequences and/or methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 4 depicts a time-sequence diagram or flow diagram 400 used to facilitate correcting false alarms associated with false distress orders in supply chain systems, in accordance with various non-limiting example embodiments. Time-sequence 400 can commence at act 402, wherein internal IT equipment (e.g., equipment associated with FIG. 14) can receive, from a customer, an order for products/services. The customer can select, using a web based application in execution on network equipment, such as a server class machine comprising at least one processor, one or more product and/or one or more associated service from a menu of products and/or service displayed on a display device. Additionally and/or alternatively, the customer can access the web based application executing on the network equipment using facilities and functionalities provided by the Internet, wherein the web based application can cause at least one display device associated with user equipment belonging to the customer, for example, to display a menu of products and/or services on offer, to be rendered on the at least one display device.

At act 404, once the customer has selected and/or confirmed purchase of their desired products and/or services, one more of a subscription draft order, price quote, and/or subscription order can be generated.

At act 406, an order book revenue item can then be created in a database of databases associated, for example, with a revenue system (e.g., revenue system 1408). The order book revenue item can be based, for example, on the total contract values for the selected products and/or services. At act 408, using facilities and functionalities associated with fulfillment system 1414, for instance, manufacturing orders for the customer ordered products and/or services can be placed with one or more corporate manufacturing entity, via networking and server equipment affiliated with the corporate manufacturing entity (e.g., manufacturing system 1418).

Also, at act 408, the one or more orders placed by the customer for products and/or services can be assigned status values, for instance, ordered booked (OB), and can also be assigned an appropriate SLA. In regard to the various SLAs, these can be determined based, for example, on agreed contract terms between a user identity and/or a customer corporate entity and the corporate entity that controls the internal IT subsystem. Also, the various SLAs can be based on contract terms between the corporate entity that controls the internal IT subsystem and one or more business entities that have been retained to manufacture the products and/or services under contract and/or intellectual property license.

At act 410, the placed order for product and/or service can be downloaded from a booking system (e.g., booking system 1404) to a fulfillment system such as fulfillment system 1414, wherein, in response to the downloading of the placed order from the booking system, fulfillment system 1414 can change the order booked (OB) status to a status of pending production (PP). Subsequently, at act 412, the fulfillment system can cause the placed order to be directed to one or more manufacturing facility (e.g., the placed order can be transmitted to at least one manufacturing system 1418) with a corresponding change, by fulfillment system 1414, of status from PP to an in production (IP) status.

In instances where the IP status has been associated with, for example, a twelve day SLA, but the manufacturing entity completes the manufacturing of the placed order in six days, the manufacturing entity can ship the manufactured product, for example, to another corporate entity responsible for incorporating additional elements to the manufactured product, such as subcontracting third party logistics business entities (e.g., corporate entities associated with logistics system 1420 and/or 3PL logistics system 1422). In response to dispatching the manufactured product to the third party logistics business entities (e.g., corporate entities associated with logistics system 1420 and/or 3PL logistics system 1422), manufacturing system 1418 can send, to fulfillment system 1414, a shipment notification, at act 414, indicating that the manufacturing process under the aegis of manufacturing system 1418 has been completed and that the manufactured product has been forwarded on to other corporate business entities for additional processing (e.g., logistics system 1420 and/or 3PL logistics system 1422). It should be observed that corporate business entities associated with logistics system 1420 and/or 3PL logistics system 1422 can be referred to as being a merger center or merge centers. Thus, once the manufacturing process has been completed and manufacturing system 1418 has forwarded the manufactured product to the merge center, and has notified, via the shipment notification, fulfillment system 1414, responsibility for communicating further statuses lie with the one or more merge centers (e.g., logistics system 1420 and/or 3PL logistics system 1422).

Now, at act 416, despite having received the manufactured product from the manufacturing entity controlling manufacturing system 1418, should the one or more merge centers fail to send an advanced shipment notification to fulfillment system 1414 indicating to fulfillment system 1414 that the one or more merge centers (e.g., logistics system 1420 and/or 3PL logistics system 1422) have delivered, or are currently in the process of delivering, the manufactured product (inclusive of additional components, instruction guides, and the like, that can have been added at merge centers in order to complete the order) to the ordering customer, the status that fulfillment system 1414, in the absence of an advanced shipment notification, still maintains is IP (rather than the ideal status that should be shipment complete (SC). It should be noted solely for the purpose of exposition of the subject disclosure rather than limitation and/or loss of generality, that where, as depicted, there are two or more merge centers (e.g., logistics system 1420 and/or 3PL logistics system 1422), rather than only one merge center, fulfillment system 1414 would need to receive advanced shipment notifications from the two or more merge centers prior to changing the IP status to a SC status. In instances, where there is but one merge center, fulfillment system 1414 would need an advanced shipment notification from the one merge center in order to shift the status from IP to SC.

Should the tracking process execute flawlessly (e.g., fulfillment system 1414 receives all notifications in an ordered and timely manner) there generally will not be an issue with the status transitions from order booked (OB) to order completed (CMP) and if needed subscription activated (SA). Where the tracking process executes in accordance with its design, at act 418, the merge centers can convey the manufactured product, together with other manufactured products completed in accordance with similar other order bookings, in a shipping container, to a carrier corporate entity (e.g., carrier system 1424) for eventual delivery to the customer at act 420. Additionally and/or alternatively, at 418 the merge centers, through the aegis of logistics system 1420 and/or 3PL logistics system 1422, can notify the carrier corporate entity (e.g., carrier system 1424) that shipping containers comprising manufactured product (and add-ons) are ready for collection by the carrier corporate entity and subsequent delivery to the customer at action 420. In response to receiving the shipping containers comprising manufactured product for distribution to one or more ordering customer, the carrier corporate entity, using carrier system 1424, can notify fulfillment system 1414, that it has possession of the ordered and manufactured product at act 422. At act 424, the carrier corporate entity can deliver the manufactured products to the one or more ordering customer, and, at act 426, can notify fulfillment system 1414 that the manufactured products have been delivered.

Nevertheless, in instances where there are discontinuities with the flow of notifications to, and/or from, fulfillment system 1414 to the various external subsystems and/or to, and/or from, the various internal IT infrastructure, distress orders can arise (e.g., the order can actually be progressing in an orderly manner through each of the systems illustrated in FIG. 14, but through miscommunication and/or failure to appropriately notify, for example, fulfillment system 1414, with an expected status updates, a distress situation can occur when one or more SLAs apparently are not satisfied). Distress orders are typically orders that have exceeded the time limits enumerated in their associated SLAs. For example, should there be a failure to communicate a notification to fulfillment system 1414 at one or more of acts 416, 418, 420, 422, 424, and/or 426, with regard to the fact that the manufacturing entity has already shipped the manufactured items to a merge center (and/or the supply-chain subsystems downstream of manufacturing system 1418), the status flag at fulfillment system 1414 can still remain as IP, whereas the reality, in this instance, is that fulfillment system 1414 should have changed the status flag, IP, with a status flag more aligned, and/or reflective, with the current reality, e.g., SC. This type of distress order can be referred to as a “false distress order”—the supply-chain as outlined is actually operating normally and correctly, but due to the fact that the various notifications from downstream supply-chain subsystems have either, not been successfully communicated to fulfillment system 1414, and/or fulfillment system 1414, on receipt of properly communicated notifications, has nonetheless failed to update the appropriate status flags, a false distress order therefore occurs.

False distress orders can be a significant wastage of resources, particularly a waste of subject matter expert (SME) time. Further, the current system is a reactive and a delayed approach to releasing orders and rectifying status data associated with the various internal IT infrastructure systems and/or internal IT infrastructure subsystems. Additionally, revenue booking performed, for example, by revenue system 1408 and/or profit system 1410 can be adversely impacted. Moreover, respective processing times associated with various order statuses and affiliated SLAs may not be accurately and/or be correctly reflected in extant supply-chain systems; which can lead to inaccurate reporting and impinge on one or more predictive models. In addition, where subscription services (e.g., maintenance services, intellectual property licenses, technology transfer licenses, and the like) are included with the ordered product, erroneous order status indicators can deleteriously delay commencement of subscription services, if any.

In regard to the various statuses outlined in this disclosure, it should be noted, without limitation and/or loss of generality, and solely for the purposes of exposition, that the many statuses can be implemented using a scheme of bit flags, stings of alphanumeric characters, systems of semaphores, and the like.

The detailed solution provided herein generally works on orders that are typically not marked as being in a final state (e.g., subscription activated (SA)). The described solution, for example, can be applicable to statuses ranging from order booked (OB) to order completed (CMP). For example, the foregoing range of statuses, without limitation, can comprise statuses related to: order booked (OB); production pending (PP); in production (IP); advanced shipment notifications (AS); shipment complete (SC); order is ready for accounting (MN); and order complete (CMP). Moreover, as has been observed above, each of the range of statuses can also be associated with groups of sub-statuses, such as, in the context of the pending production (PP) status, its sub-statuses can be (i) order routed; (ii) work order created, (iii) licenses obtained, (iv) purchase order generated, (v) order scheduled

Further the described solution creates, generates, and/or executes one or more artificial intelligence (AI) models to identify and determine occurrences of anomalous order statuses, and to provide SMEs with tools for correcting the determined anomalous order statuses. In instances where the AI models, based, for example, on hierarchical classification infrastructures, misidentify anomalous order statuses and/or provide SMEs with incorrect information concerning the tools and/or information needed to remedy determined anomalous order statuses, feedback or loopback mechanisms can be in place to refine the one or more AI models, thereby ensuring that the developed AI models can continuously learn and/or can be refined based on past possibly erroneous and/or probably misidentified anomalous order statuses.

At this juncture, prior to a more extensive explication of the detailed solution, it should be noted that the supply-chain infrastructure (e.g., internal IT subsystems and external subsystems illustrated as system 1400) can have hierarchical relationships in relation to how an order tracks through system 1400. Some illustrative orders can be referred to as a “direct order”-an order that ships directly to the customer and can have the following example hierarchical relationship structure.

### Direct Order: IT Internal Systems→Logistics→Carrier→Customer

The foregoing example hierarchical pattern can imply that in response to receiving an order being placed by a customer, the order can initially be processed and handled by the internal IT subsystems; the order can then be directed to one or more logistics system (e.g., logistics system 1420 and/or 3PL logistics system 1422); after which the order can be sent to a carrier system (e.g., carrier system 1424) for delivery to the ordering/purchasing customer.

Other example orders can be referred to as a “2^{nd} Touch Order”—where the order, once placed with the internal IT subsystems, is sent to an internal manufacturing subsystem (not depicted in system 1400); is sent to an external manufacturing entity (e.g., manufacturing system 1418); then is sent to one or more logistics system (e.g., logistics system 1420 and/or 3PL logistics system 1422), and then to a carrier entity (e.g. carrier system 1424), which in turn delivers the completed order to the ordering/purchasing customer. This hierarchical relationship can illustratively be represented as:

### 2^{nd} Touch Order: IT Internal Systems→Internal Manufacturing→External Manufacturing→Logistics→Carrier→Customer

Additional orders can be referred to as a “Pick Order”—where the customer order can be satisfied by a possibly pre-stocked third party vendor system (e.g., vendor system 1416). Such an order can be represented by the following hierarchical relationship:

### Pick Order: IT Internal Systems→Internal Logistics→External Logistics→Carrier→Customer

Order status propagation, for example, in some embodiments, can place a heavy reliance on such hierarchical relationships, and as such the described subject matter can use these hierarchical relationships to facilitate the detection and/or correction of false alarms associated with false distress orders in supply chain systems.

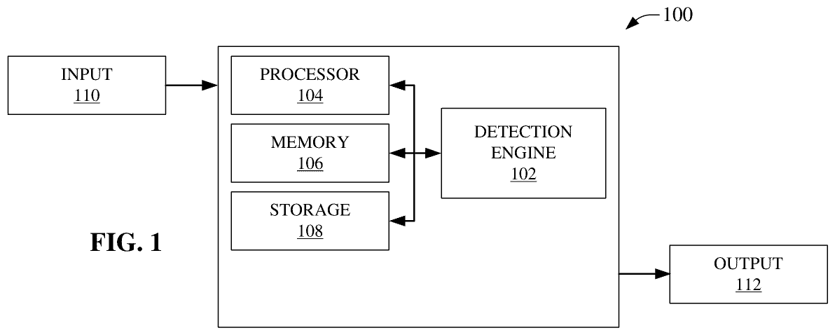

With reference to FIG. 1 depicted therein is a system 100 for correcting false alarms associated with false distress orders in supply chain systems, in accordance with various non-limiting example embodiments. System 100, for purposes of illustration, can be any type of mechanism, machine, device, facility, apparatus, and/or instrument that includes a processor and/or is capable of effective and/or operative communication with a wired and/or wireless network topology. Mechanisms, machines, apparatuses, devices, facilities, and/or instruments that can comprise system 100 can include tablet computing devices, handheld devices, server class computing equipment, machines, and/or database equipment, laptop computers, notebook computers, desktop computers, cell phones, smart phones, consumer appliances and/or instrumentation, industrial devices and/or components, hand-held devices, personal digital assistants, multimedia Internet enabled phones, Internet of Things (IoT) equipment, multimedia players, and the like.

System 100 can comprise detection engine 102 that can be in operative communication with processor 104, memory 106, and storage 108. Detection engine 102 can be in communication with processor 104 for facilitating operation of computer-executable instructions or machine-executable instructions and/or components by detection engine 102; memory 106 for storing data and/or computer-executable instructions and/or machine-executable instructions and/or components; and storage 108 for providing longer term storage of data and/or machine-readable instructions and/or computer-readable instructions. Additionally, system 100 can also receive input 110 for use, manipulation, and/or transformation by detection engine 102 to produce one or more useful, concrete, and tangible result, and/or transform one or more articles to different states or things. Further, system 100 can also generate and output the useful, concrete, and tangible result and/or the transformed one or more articles as output 112.

Detection engine 102 can take all active orders for products/service that can have been received from one or more customers, determine whether not the active orders have passed at least half of the SLA associated with a defined status (e.g., IP, PP, etc.), and thereafter query each of the subsystems, both internal IT subsystems and/or external subsystems, to assess and/or evaluate whether the order is “actually in distress.” For example, if an order for products/services has been associated with a status of IP, and the IP status has in turn been affiliated with a SLA that requires processing, while in the IP status, to be completed within a defined period of time (e.g., 24 hours), once the defined period of time has been exceeded by defined additional grace period (e.g., 12 additional hours-making for a total elapsed time from the initiation of the IP status as being 36 hours), detection engine 102 can mark this order as being a “suspected distress” order.

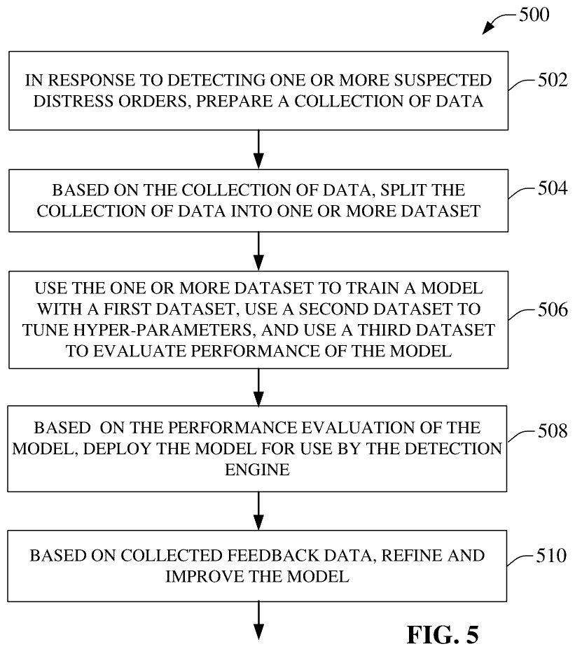

In response to identifying that an order is a suspect distress order, detection engine 102 can initiate execution of method 500 that is illustrated in FIG. 5. Thus, in accordance with method 500, detection engine 102, in response to detecting one or more suspect distress orders, can verify whether or not the suspected distress orders are truly “false distress order alarms (FDOAs).” Detection engine 102 can determine whether a suspected distress order is actually a false distress order alarm (forthwith referred to as a “false distress order”) by categorizing or classifying the suspected distress order. In order to accomplish this, detection engine 102, at act 502, can classify the suspected distress order by performing a data preparation operation, wherein one or more suspected distress orders can be analyzed based on a feature selection.

Feature selection can comprise using one or more features of the suspected distress order that can have been identified earlier by detection engine 102. The one or more features can comprise information such as: product data; product type data (e.g., software, hardware); order type data (e.g., direct order, 2^{nd} touch order, pick order, and the like); country data; failed location data (categorical variable(s) related to which subsystems of the collection of internal and/or external subsystems were the point of failure); rationale data (e.g., the reason for the failures); and recovery time data (e.g., time durations of the failures). In the context of categorical variables or qualitative variables, these variables can take on one of a limited, fixed, number of possible values, assigning each individual or other unit of observation to a particular group or nominal category on the basis of a qualitative property. Additionally, categorical variables can be referred to as enumerations or enumerated types.

Additional features that can also be used, at act 502, in relation to the data preparation operation, can comprise information such as: time of day data (e.g., when the order was placed and/or when the failure occurred); order volume data (e.g., number of units ordered); order value data (e.g., total value of the order); if available, customer segment data (e.g., an identification as to whether certain customer types are more prone to distress orders); and processing time data (e.g., time taken from order placement to the time when the failure occurred).

Further, at act 502, a data encoding operation can be performed to encode categorical variables such as product data, product type data, order type data, country data, failed location data, reason for failure data. Data encoding generally converts categorical variables into numeral formats. The conversion of categorical variables into numeral format can be accomplished using label encoding (e.g., converting categorical variables into numerical representations so that the categorical variables comport with machine learning models that typically only accept numerical data), and/or one-hot encoding (e.g., an encoding technique in which categorical variables are converted to a group of bits among which the only authorized combinations of values are those with a single high (1) bit and all the other bits are low (0) bits).

Also, at act 502, a process can be performed in order to handle missing values, wherein any missing values can be substituted with median, mean, and/or modal values. Further, missing values can be substituted using imputation techniques such using an expectation-maximization process, wherein omitted values are typically substituted based on estimations of what the values should be by taking into account patterns within the missing values.

Also, at act 502, detection engine 102 can perform feature scaling thus ensuring that all features are on a similar scale. Feature scaling generally normalizes the range of independent variables or features of data. Feature scaling can help with model convergence and interpretability. In some embodiments of the disclosed subject matter, feature scaling can be accomplished by performing min-max scaling or min-max normalization, wherein the scaling and/or rescaling comprises scaling each of the features to a scale in the range of [0, 1] or [−1, 1]. In other additional and/or alternative embodiments, feature scaling can be accomplished using a technique known as feature standardization that can make the values of each feature in a dataset have a zero-mean value and a unit-variance. A broad outline of the feature standardization technique comprises determining a distribution mean and a standard deviation for each feature comprising the dataset of features; subtracting the mean from each of feature; and then dividing the values of each feature by its associated standard deviation.

At act 504, detection engine 102, based on the collection of data prepared at act 502, can split the collection of data into one or more dataset. For example, at act 504, detection engine 102 can split the one or more dataset into a first dataset representing training data that can be used to create, develop, and train a model (e.g., an AI model), a second dataset representing validation data that can be used to tune hyper-parameters associated with the AI model, and a third dataset representing test data that can be used to evaluate performance of the developed AI model. Typically, a common ratio for splitting the collection of data can be 70% for the training data, 15% for validation data, and 15% for test data.

Subsequent to splitting the collection of data into one or more dataset, detection engine 102, at act 506, can perform model training using the first dataset (training data). Model testing can comprise selecting a gradient boosting framework such as a gradient boosting library that can provide a regularizing gradient boosting framework for a disparate panoply of open-source programming languages (e.g., C++, Java, Python, Perl, etc,) operational on a diverse group of operating system platforms. Once a gradient boosting framework has been selected, the AI model can be initialized using a group of default parameters. An example Python code fragment that can be used to initialize the AI model is presented below:
pythonCopy code
from sklearn.ensemble import GradientBoostingClassifier
model=GradientBoostingClassifier( )
   Additionally, in response to the AI model being initialized, and by using the first dataset (training data), the AI model can be trained to fit the initialized AI model. A further Python example code segment that can be utilized to facilitate training of the AI model is presented below:
pythonCopy code
model.fit(X_train, y_train)

Also, at act 506, detection engine 102 can also perform hyper-parameter tuning of the AI model. Hyper-parameter tuning of the AI model can involve using a grid search or randomized search with cross-validation to identify hyper-parameters that either maximize and/or minimize n_estimators—the number of boosting stages to be run, and max_depth—a defined maximum depth value associated with individual estimators, and thereafter using the second dataset (validation dataset) to evaluate the performance of disparate hyper-parameters.

Additionally, at act 506, detection engine 102 can perform one or more model evaluations using the second dataset (validation data) to evaluate the developed AI model's performance. Common criteria for classification problems and/or model evaluation can include accuracy, precision, recall, Fl score, and/or confusion matrices (e.g., a data structure, typically a table data structure, that allows for visualization of the performance of a process in execution; the data structure generally comprises rows and columns and typically indicates the number of true positives, false negatives, false positives, and/or true negatives). Fl scores are typically a measure of a model's accuracy in relation to a dataset. Fl scores are generally used to classify examples into positive or negative, and is a way of combining the precision and recall of the model. As a general rule, an Fl score is the harmonic mean of a model's precision and recall.

Further, at act 506, detection engine 102, contemporancously (and/or in near contemporaneity) with performing model evaluations of the developed AI model's performance, can analyze feature importance to determine which features are driving predictions. It has been found that analysis of feature importance can provide insights into the process and provide suggested areas for improvement.

At act 508, detection engine 102, based at least in part on one or more prior test execution of the developed AI model using the first dataset, the second data set, and/or the third dataset, and the collections of performance evaluation data associated with the prior test executions of the developed AI model, the developed AI model can be deployed and placed into a production environment for use by detection engine 102. Deployment of the tested and developed AI model into a production environment can entail employing the AI model to classify new incoming orders for products and/or services in real-time and/or in batches. Further, at act 508, detection engine 102 can continuously monitor the now implemented AI model's performance over defined periods of time. Should the implemented AI model begin providing erroneous or questionable results, the implemented AI model can be retrained with new datasets (e.g., with incoming data that can be collected while the implemented model is in operation) or the hyper-parameters can be adjusted in order to maintain or improve performance of the implemented AI model while it is in operation.

At act 510, detection engine 102, when necessary and/or as required, can improve performance of the implemented AI model by collecting feedback data on the implemented AI model's predictive capabilities in relation to actual outcomes to better identify discrepancies and recognize areas for improvement. In instances where detection engine 102 recognizes areas for improvement and/or identifies discrepancies, it can use new data and earlier collected datasets to refine the AI model that is in implementation, and can adjust and modify one or more of the preprocessing acts, such as modifications to the data preparation act, the act of dataset splitting, the act of model training, and/or the act of model evaluation.

Once the developed AI model is placed into a production environment, detection engine 102, using its own functionalities and/or facilities in conjunction with the earlier described AI model (e.g., an AI model developed using a gradient boosting framework), for example, can identify a distressed order (e.g., a distress order) based on a contravention of one or more SLA associated with transitions of state from a first state to a second state (e.g., PP to IP, IP to SC, SC to MN, etc.); and determine that the identified distressed order is actually a false distress order (e.g., an order that though been earmarked, by detection engine 102, as being a distress order, has in actual fact satisfactorily transitioned, without issue, to a desired end state or final state (e.g., MN to CMP, CMP to SA, etc,). Concerning the identification of distress orders a scheduling process operational on system 100 can be executed at defined time intervals (e.g., hourly, after the elapse of three hours, every six hours, every twelve hours, daily, weekly, etc.) to query all subsystems (internal IT subsystems and, where possible, external subsystems) to determine the current state of an order. For example, if the order's current state is IP, the query process can, as necessary, communicate with each downstream subsystems (e.g., revenue system 1409, profit system 1410, . . . , vendors system NUMPTY16, manufacturing system 1418, logistics system 1420, 3PL logistics system 1422, and/or carrier system 1424) to trace where, in a chain of linked transitions, a transition link was severed. The point at which the transition link was severed can then be a source of the false distress order and as such the identified false distress order can be returned to detection engine 102 for further analysis.

It should be observed that identification of false distress orders, in contrast to actual distress orders (e.g., those that require SME attention), can be an indication that the progression of orders through system 1400 is satisfactory, but nonetheless that there appears to be problem with one or more of the internal and/or external subsystems not updating the status of the order to reflect the actual (true) status of the order, as required. It should also be noted that where a false distress order is identified and the order has already achieved a desired end state or final state, the SLA for each of the transition states subsequent to the severed transition link may not, in reality, have been breached. The only issue in this scenario is that time(s) associated with the processing of the order in each of the processing stages (e.g., OB, PP, IP, SC, . . . ) at the point of failure and downstream of the point of failure need to be allocated time duration values (e.g., time values that can be based on past/historical time values within which processing of the order generally/typically take to be processed). For example, if the subsystem identified as being a source of a false distress order is logistics system 1420 having not reported back a status, for example, to fulfillment system 1414, in regard to the status transition that occurred to 3PL logistics system 1422, appropriate time values will now need to be assigned for the time during which the order was being processed by logistics system 1420, and possibly, 3PL logistics system 1422, and carrier system 1424.

In order to address the foregoing issue related to assigning or allocating defined or definable time processing values for omitted time values associated with the processing of the order in each of the processing stages at, or downstream of, the identified point of failure, detection engine 102 in conjunction, for example, with the classification model described above (e.g., the classification model generated and trained using a gradient boosting framework and based on the hierarchical nature of the subsystems in a supply-chain system, such as system 1400) can develop and employ a machine learning model to predict the time spent in previous statuses for an identified false distress order.

Generally, an active dataset can comprise all active orders for products/services that can have been received from one or more customers, as well as historical datasets that can have been aggregated over time for all past orders for products/services. In recognition that the historical datasets and the active dataset, in their totalities, can be significantly large, it is proposed to use data within the active dataset and/or the historical datasets that can have been labeled as being in “good_order.” Accordingly, orders that are labeled as being “good_order” can be classified between a status (e.g., PP, IP, SC, MN, . . . ) and an associated time taken for each order. Thereafter, features associated with the order, for example, order type, country, and the like, and a target time taken at each step can be added. In regard to the times taken and associated with each order, these can be adjusted for seasonality (e.g., Black Friday, Christmas, Thanksgiving, July the 4^{th}, Easter, summer, autumn, winter, . . . ).

To accomplish predicting the times spent in previous status states for false distress orders, a randomized forest regression model can be created and developed. Thus, once detection engine 102 has identified a false distress order based on the use of classifications generated earlier, detection engine 102 can determine a defined time based on the time that an order spent in each of the prior subsystems before the point of failure. For example, if the order for product/services appears to be stuck in the IP status, but the factual status should be MN, these details can be conveyed to a model that provides a predicted time duration value within which the order was being processed in each of the IP state, the SC state, and/or the MN state. These predicted time duration values can then be used to update the omitted and/or erroneous time values associated with each of the states through which the order has already been passed.

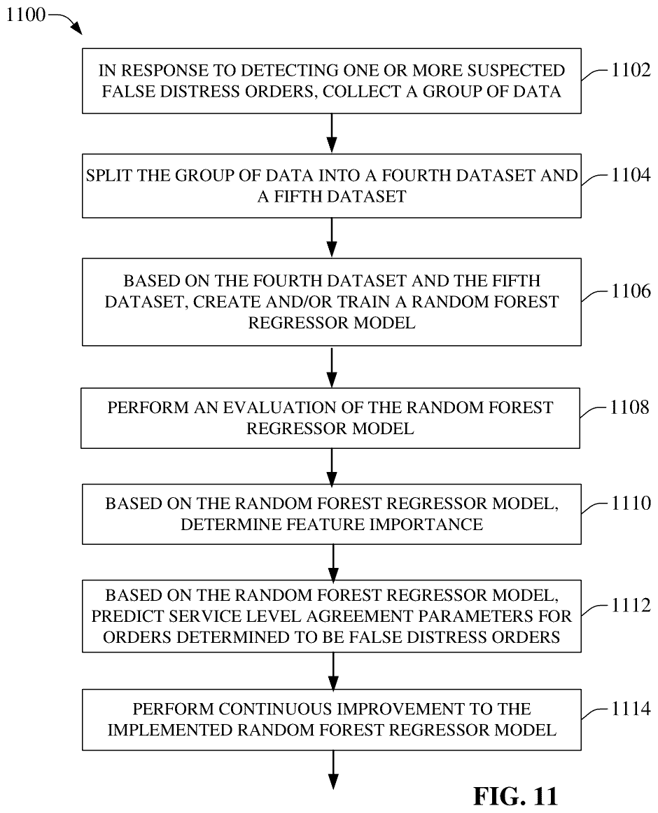

With reference now to FIGS. 1 and 11, detection engine 102, in response to detecting one or more suspected false distress order, at act 1102, can collect and create a dataset that comprises orders for which the order was labeled as being in good order (e.g., good_order). Orders that have been labeled as being in good order are typically those orders that have passed through system 1400 without having raised any distress signals. Features of such “good_orders” can comprise order attributes such as product, product type, order type, country, etc. Other features associated with “good_orders” can include processing times or timestamps at various stages (e.g., order placed, order booked, etc.). Additional features can include those that can impact one or more SLA (e.g., order volume, customer segment, and the like).

At act 1102, detection engine 102 can also determine a target variable value. Identified target variable values can be based on the actual time taken for an order to transition from a first status to a second status, and/or the identified target variable value can be based on when an order was placed to when the ordered product was finally ship, depending on what SLA you wish to select.

Further, at act 1102, detection engine 102 can perform acts of data cleaning and/or data pre-processing, wherein categorical variables can be encoded using one or more of one-hot encoding and/or label encoding. As detailed above, label encoding entails converting categorical variables into numerical representations so that the categorical variables comport with machine learning models that typically only accept numerical data), and one-hot encoding entails converting categorical variables to groups of bits among which the only permissible combinations of values are those with a single high (1) bit while all the other bits are low (0) bits. Further, the acts of data cleaning and/or pre-processing can also include appropriately handling missing data. Once detection engine 102 can split the dataset into feature (x) arrays and target (y) arrays.

At act 1104, detection engine 102 can split the cleaned and preprocessed dataset into a fourth dataset representing a training dataset and a fifth dataset representative of a testing dataset. The fourth dataset and the fifth dataset can be used to evaluate the performance of the generated model (e.g., a random forest regression model). With regard to splitting the cleaned and preprocessed dataset into the fourth dataset and the fifth dataset, a common split ratio can be 80% for training and 20% for testing. The illustrative code fragment below can be employed to split the cleaned and preprocess dataset into the fourth dataset and the fifth dataset:
pythonCopy code
from sklearn.model_selection import train_test_split
X_train, X_test, y_train, y_test=train_test_split (X, y, test_size=0.2, random_state=42)

At act 1106, detection engine 102 can train a random forest regression model by initializing the model through the use of scikit-learn's RandomForestRegressor. The following illustrative code fragment can be used to initialize the model:
pythonCopy code
from sklearn.ensemble import RandomForestRegressor
rf_regressor=RandomForestRegressor(n_estimators=100, random_state=42

Further, at act 1106, detection engine 102 can train the random forest regression model using the fourth dataset (training dataset). The following example code sequence can be used to accomplish training of the model:
pythonCopy code
rf_regressor.fit(X_train, y_train)

At act 1108, detection engine 102 can train the random forest regression model's performance based on the testing dataset using appropriate metrics for regression. Example and appropriate regression metrics can comprise: mean absolute error (MAE) metrics, mean squared error (MSE) metrics, and/or root mean squared error (RMSE) metrics. MAE metrics are generally a measure of errors between paired observations; and are but one of a number of ways of comparing forecasts with their eventual outcomes. MSE metrics are a measure of the average of the squares of the errors (e.g., the average squared difference between an estimated value and an actual value). RMSE metrics measures differences between true or predicted values and observed values or an estimator (e.g., an estimate of a given quantity based on observed data). It should be observed that there is a discernible distinction between MAE metrics and RMSE metrics as using MAE metrics provides the average absolute vertical or horizontal distance between each point in a scatter plot and a Y=X line. Thus, MAE metrics averages an absolute difference between X and Y, wherein each error contributes to a MAE metric in proportion to the absolute value of the error. RMSE metrics, in contrast, involves squaring the differences, so that a few large differences can increase a RMSE metric to a greater degree than a MAE metric. Presented below is an example code segment that can be used to evaluate the developed random forest regression model's performance based at least in part on the testing dataset:
pythonCopy code
from sklearn.metrics import mean_squared_error, mean_absolute_error
y_pred=rf_regressor.predict(X_test)
mse=mean_squared_error(y_test, y_pred)
rmse=mse**0.5
mae=mean_absolute_error(y_test, y_pred)
print (f″MAE: {mae}, RMSE: {rmse}”)

Next, at act 1110, detection engine 102, based on the evaluated random forest regression model, can determine which features are the most influential or important in predicting SLA values, and can aid in focusing on critical aspects of the supply-chain, as depicted in FIG. 14. The below illustrative code fragment uses scikit-learn's Random forest regression implementation to provide access to feature importance:
pythonCopy code
feature_importances=rf_regressor.feature_importances_

Thereafter, detection engine 102, at act 1112, based on the developed random forest regression model, can predict SLA time value data for orders determined to be false distress orders. These predictions can be used to adjust records to reflect predicatively correct SLA time values based on the random forest regression model's estimations.

Detection engine 102, at act 1114, can perform continuous improvement function with regard to the random forest regression model. Thus, at action 1114, detection engine 102 can perform model tuning whereby the random forest regression model's hyper-parameters (e.g., n_estimators, max_depth, . . . ) can be tuned to improve the random forest regression model's performance. Tools such as GridSearchCV or RandomizedSearchCV, can aid in this functionality. Further, at act 1114, detection engine 102, regularly at, or after, the elapse defined periods of time, can retrain the developed random forest regression model using new data to ensure that the random forest regression model remains accurate over time. Additionally, detection engine, at act 1114, can provide functionalities and/or facilities to implement a feedback mechanism to compare predicted SLA time values against actual time values, and thereafter refine the developed random forest regression model.

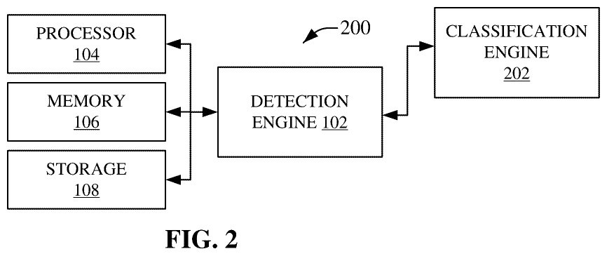

Now in reference to FIG. 2 that depicts a further illustration of system 100, now labelled as system 200, that corrects false alarms associated with false distress orders in supply chain systems, in accordance with various non-limiting example embodiments. As illustrated, system 200, in addition to detection engine 102, can comprise classification engine 202 that can operate in collaborative conjunction with detection engine 100. Classification engine 202 can take all active orders for products/service that can have been received from one or more customers, determine whether not the active orders have passed at least half of the SLA associated with a defined status (e.g., IP, PP, etc.), and thereafter query each of the subsystems, both internal IT subsystems and/or external subsystems, to assess and/or evaluate whether or not the order is “actually in distress.” For instance, if an order for products/services has been associated with a status of IP, and the IP status has in turn been affiliated with a SLA that requires processing, while in the IP status, to be completed within a defined period of time (e.g., 24 hours), once the defined period of time has been exceeded by defined additional grace period (e.g., 12 additional hours-making for a total elapsed time from the initiation of the IP status as being 36 hours), classification engine 202 can mark this order as being a “suspected distress” order.

In response to identifying that an order is a suspect distress order, classification engine 202 can verify whether or not the suspected distress orders are truly “false distress order alarms (FDOAs).” Classification engine 202 can determine whether a suspected distress order is actually a false distress order alarm (forthwith referred to as a “false distress order”) by categorizing or classifying the suspected distress order. In order to accomplish this, classification engine 202 can classify the suspected distress order by performing a data preparation operation, wherein one or more suspected distress orders can be analyzed based on a feature selection.

Feature selection, as stated earlier, can comprise using one or more features of the suspected distress order that can have been identified earlier by classification engine 202. The one or more features can comprise information such as: product data; product type data; order type data; country data; failed location data (e.g., categorical variable(s) related to which subsystems of the collection of internal and/or external subsystems were the point of failure); rationale data; and/or recovery time data.

Further, classification engine 202 can perform a data encoding operation to encode categorical variables such as product data, product type data, order type data, country data, failed location data, reason for failure data. Data encoding, as observed above, generally converts categorical variables into numeral formats. The conversion of categorical variables into numeral formats can be accomplished using label encoding and/or one-hot encoding.

Classification engine 202 can also perform processes in order to handle missing values, wherein any missing values can be substituted with median, mean, and/or modal values. Further, missing values can also be substituted using imputation techniques such using an expectation-maximization process, wherein omitted values are typically substituted based on estimations of what the values should be by taking into account patterns within the missing values.

Additionally classification engine 202 can perform feature scaling thereby ensuring that all features are on a similar scale. Feature scaling normalizes the range of independent variables or features of data, and aids with model convergence and interpretability. Feature scaling, as observed above, can be accomplished by performing min-max scaling or min-max normalization, wherein the scaling and/or rescaling comprises scaling each of the features to a scale in the range of [0, 1] or [−1, 1]. Additionally and/or alternatively feature scaling can be accomplished using a technique known as feature standardization that can make the values of each feature in a dataset have a zero-mean value and a unit-variance. A broad outline of the feature standardization technique comprises determining a distribution mean and a standard deviation for each feature comprising the dataset of features; subtracting the mean from each of feature; and then dividing the values of each feature by its associated standard deviation.

Classification engine 202, based on the collection of data prepared earlier, can split the collection of data into one or more dataset. For example, classification engine 202 can split the one or more dataset into a first dataset representing training data that can be used to create, develop, and train a model (e.g., an AI model), a second dataset representing validation data that can be used to tune hyper-parameters associated with the AI model, and a third dataset representing test data that can be used to evaluate performance of the developed AI model. Common ratios for splitting the collection of data can be 70% for the training data, 15% for validation data, and 15% for test data.

Subsequent to splitting the collection of data into one or more dataset, classification engine 202 can perform model training using the first dataset. Model training can comprise selecting a gradient boosting framework such as a gradient boosting library that can provide a regularizing gradient boosting framework for a disparate panoply of open-source programming languages (e.g., C++, Java, Python, Perl, etc,) operational on a diverse group of operating system platforms. Once a gradient boosting framework has been selected, an AI model can be initialized using a group of default parameters. Additionally, in response to the AI model being initialized, and by using the first dataset (training data), the AI model can be trained to fit the initialized AI model.

Classification engine 202 can also perform hyper-parameter tuning of the AI model. Hyper-parameter tuning of the AI model can involve using a grid search or randomized search with cross-validation to identify hyper-parameters that either maximize and/or minimize n_estimators—the number of boosting stages to be run, and max_depth—a defined maximum depth value associated with individual estimators. After performing the grid search or randomized search to identify hyper-parameters that either maximize and/or minimize values for n_estimators and max_depth the second dataset (validation data) can be used to evaluate the performance of the different hyper-parameters

Additionally classification engine 202 can perform one or more model evaluations using the third dataset (test data) to evaluate the developed AI model's performance. As observed above, common criteria for classification problems and/or model evaluation can include accuracy, precision, recall, Fl score, and/or confusion matrices.

Further classification engine 202, contemporaneously (and/or in near contemporaneity) with performing model evaluations of the developed AI model's performance, can analyze feature importance to determine which features are driving predictions. It has been found that analysis of feature importance can provide insights into the process and provide suggested areas for improvement.

Classification engine 202, based at least in part on one or more prior test execution of the developed AI model using the first dataset, the second data set, and/or the third dataset, and the collections of performance evaluation data associated with the prior test executions of the developed AI model, the developed AI model can be deployed and placed into a production environment for use by detection engine 102. As stated above, deployment of the tested and developed AI model into a production environment can entail employing the AI model to classify new incoming orders for products and/or services in real-time and/or in batches. Further, classification engine 202 can continuously monitor the now implemented AI model's performance over defined periods of time. Should the implemented AI model begin providing erroneous or questionable results, the implemented AI model can be retrained with new datasets (e.g., with incoming data that can be collected while the implemented model is in operation) or the hyper-parameters can be adjusted in order to maintain or improve performance of the implemented AI model while it is in operation.

Classification engine 202, when necessary and/or as required, can improve performance of the implemented AI model by collecting feedback data on the implemented AI model's predictive capabilities in relation to actual outcomes to better identify discrepancies and recognize areas for improvement. In instances where classification engine 202 recognizes areas for improvement and/or identifies discrepancies, it can use new data and earlier collected datasets to refine the AI model that is in implementation, and can adjust and modify one or more of the preprocessing acts, such as modifications to the data preparation act, the act of dataset splitting, the act of model training, and/or the act of model evaluation.

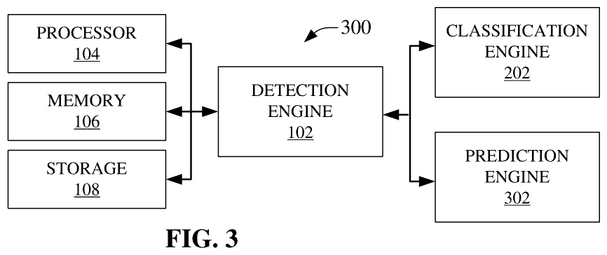

To accomplish predicting the times spent in previous status states for false distress orders, a randomized forest regression model can be created and developed. In order to generate and develop a randomized forest regression model a prediction engine 302, illustrated in FIG. 3, can be employed. Thus, once detection engine 102 has identified a false distress order based on the use of classifications generated earlier, the illustrated prediction engine 302 can determine a defined time based on the time that an order spent in each of the prior subsystems before the point of failure. For example, if the order for product/services appears to be stuck in the IP status, but the factual status should be MN, these details can be conveyed to a model that provides a predicted time duration value within which the order was being processed in each of the IP state, the SC state, and/or the MN state. These predicted time duration values can then be used to update the omitted and/or erroneous time values associated with each of the states through which the order has already been passed.

With reference now to FIG. 3 that depicts a further illustration of Systems 100 and 200, now labelled as system 300, which corrects false alarms associated with false distress orders in supply chain systems, in accordance with various non-limiting example embodiments. FIG. 3, in addition to detection engine 102 and classification engine 202, depicts prediction engine 302 that can operate in collaboration with detection engine 102 and classification engine 202. Prediction engine 302, in response to detecting one or more suspected false distress order can collect and create a dataset that comprises orders for which the order was labeled as being in good order (e.g., good_order); orders that have been labeled as being in good order are typically those orders that have passed through the entirety of system 1400 without having raised any distress signals.

Further, prediction engine 302 can also determine a target variable value. Identified target variable values can be based on the actual time taken for an order to transition from a first status to a second status, and/or the identified target variable value can be based on when an order was placed to when the ordered product was finally ship, depending on what SLA you wish to select.

Prediction engine 302 can perform the acts of data cleaning and/or data pre-processing, wherein categorical variables can be encoded using one or more of one-hot encoding and/or label encoding. As noted above, label encoding converts categorical variables into numerical representations so that the categorical variables comport with machine learning models that typically only accept numerical data, and one-hot encoding converts categorical variables to groups of bits among which the only permissible combinations of values are those with a single high (1) bit while all the other bits are low (0) bits. Further, the acts of data cleaning and/or pre-processing can also include appropriately handling missing data.

Prediction engine 302 can split the cleaned and preprocessed dataset into a fourth dataset representing a training dataset and a fifth dataset representative of a testing dataset. The fourth dataset and the fifth dataset can be used to evaluate the performance of the generated model (e.g., a random forest regression model). With regard to splitting the cleaned and preprocessed dataset into the fourth dataset and the fifth dataset, a common split ratio can be 80% for training and 20% for testing.

Prediction engine 302 can then train a random forest regression model by initializing the model through the use of scikit-learn's RandomForestRegressor, as noted above, and then train the random forest regression model's performance based on the testing dataset using appropriate metrics for regression. Appropriate regression metrics can comprise: MAE metrics, MSE metrics, and/or RMSE metrics.

Next, prediction engine 302, based on the evaluated random forest regression model, can determine which features are the most influential or important in predicting SLA values, and can aid in focusing on critical aspects of the supply-chain, as depicted in FIG. 14.

Thereafter, prediction engine 302, based on the developed random forest regression model, can predict SLA time value data for orders determined to be false distress orders. These predictions can be used to adjust records to reflect predicatively correct SLA time values based on the random forest regression model's estimations.

Prediction engine 302 can perform continuous improvement functions with regard to the random forest regression model. Thus, prediction engine 302 can perform model tuning whereby the random forest regression model's hyper-parameters can be tuned to improve the random forest regression model's performance. Further, prediction engine 302, regularly at, or after, the elapse defined periods of time, can retrain the developed random forest regression model using new data to ensure that the random forest regression model remains accurate over time. Additionally, prediction engine 302 can provide functionalities and/or facilities to implement a feedback mechanism to compare predicted SLA time values against actual time values, and thereafter refine the developed random forest regression model.

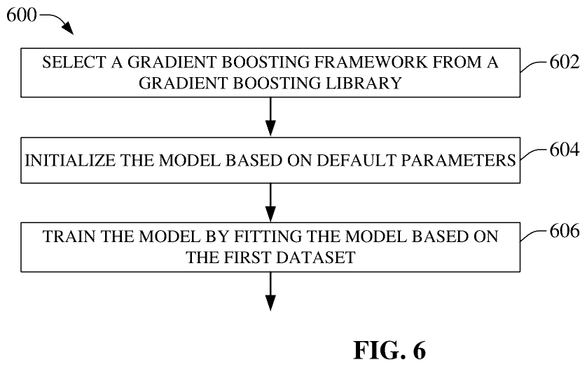

With reference to FIG. 6 that illustrates time-sequence diagram, flow diagram, or method 600 that can be used by detection engine 102 and/or classification engine 202 to facilitate correction of false alarms associated with false distress orders in supply chain systems, in accordance with various non-limiting example embodiments. Method 600 can commence, at act 602, where a gradient boosting framework, such as a gradient boosting library that can provide a regularizing gradient boosting framework for disparate open-source programming languages operational on a diverse group of operating system platforms, can be selected. Once a gradient boosting framework has been selected at act 602, at act 604, an AI model can be initialized using a group of default parameters. Additionally, in response to the AI model being initialized at act 604, at act 606, by using the first dataset (training data), the AI model can be trained to fit the initialized AI model.

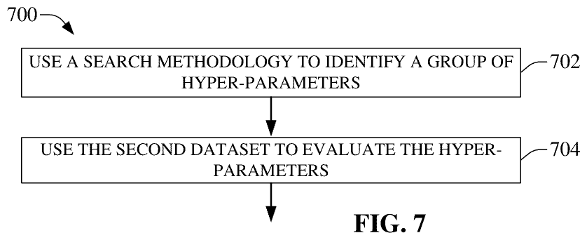

FIG. 7 illustrates another time-sequence diagram, flow diagram, or method 700 that can be used by detection engine 102 and/or classification engine 202 to facilitate correction of false alarms associated with false distress orders in supply chain systems, in accordance with various non-limiting example embodiments. Method 700 can commence at act 702 wherein a grid search or randomized search with cross-validation can used to identify hyper-parameters that either maximize and/or minimize n_estimators and max_depth. At act 704, one or more model evaluations using the second dataset (validation data) can be performed in order to evaluate the developed AI model's performance based on different hyper-parameters.

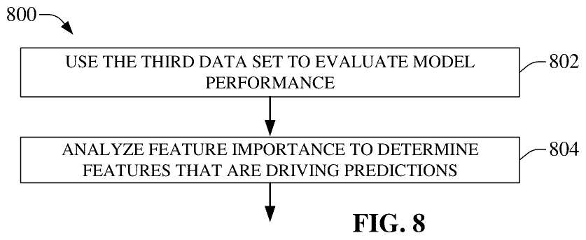

FIG. 8 depicts a further time-sequence diagram, flow diagram, or method 800 that can be used, by detection engine 102 and/or classification engine 202 to facilitate correction of false alarms associated with false distress orders in supply chain systems, in accordance with various non-limiting example embodiments. Method 800 can begin at act 802, where one or more model evaluations using the third dataset (test data) to evaluate the developed AI model's performance can be conducted. At act 804, classification engine 202 can also analyze feature importance to determine which features are driving predictions.

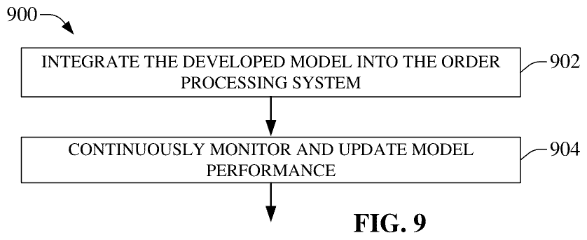

FIG. 9 illustrates yet another time-sequence diagram or flow diagram 900 that can be used by detection engine 102 and/or classification engine 202 to facilitate correction of false alarms associated with false distress orders in supply chain systems, in accordance with various non-limiting example embodiments. Method 900 begins at act 902, wherein one of detection engine 102 and/or classification engine 202, based at least in part on one or more prior test execution of the developed AI model using the first dataset, the second data set, and/or the third dataset, and the collections of performance evaluation data associated with the prior test executions of the developed AI model, the developed AI model, at act 902, can be deployed and placed into a production environment for use by detection engine 102. Placing the tested and developed AI model into a production environment can entail employing the AI model to classify new incoming orders for products and/or services in real-time and/or in batches. Further, at act 904, detection engine 102 can continuously monitor the now implemented AI model's performance over defined periods of time, wherein should the implemented AI model begin providing erroneous or questionable results, the implemented AI model can be retrained with new datasets (e.g., with incoming data that can be collected while the implemented model is in operation) or the hyper-parameters can be re-tuned in order to maintain or improve performance of the implemented AI model while it is in operation.

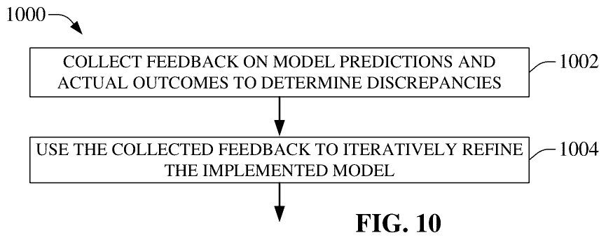

FIG. 10 depicts another time-sequence diagram, or flow diagram, or method 1000 that can be used, by detection engine 102 and/or classification engine 202 to facilitate correction of false alarms associated with false distress orders in supply chain systems, in accordance with various non-limiting example embodiments. Method 1000 commences at act 1002 where detection engine 102 and/or classification engine 202, when necessary and/or as required, can improve performance of the implemented AI model by collecting feedback data on the implemented AI model's predictive capabilities in relation to actual outcomes to better identify discrepancies and recognize areas for improvement. In instances where detection engine 102 and/or classification engine 202, recognizes areas for improvement and/or identifies discrepancies, detection engine 102 and/or classification engine 202, at act 1004, it can use new data and earlier collected datasets to iteratively refine the AI model that is in implementation, and can adjust and modify one or more of the preprocessing acts, such as modifications to the data preparation act, the act of dataset splitting, the act of model training, and/or the act of model evaluation.

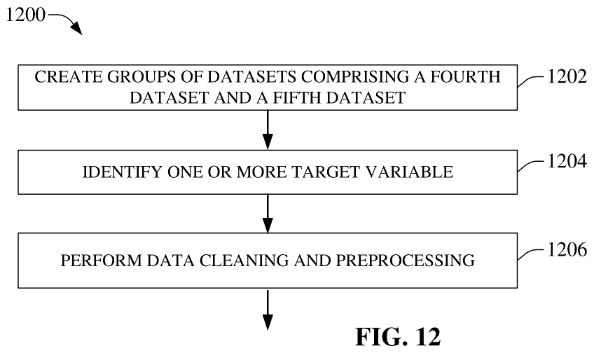

FIG. 12 illustrates an additional time-sequence diagram, flow diagram, or method 1200 that can be used, by detection engine 102 and/or prediction engine 302 to facilitate correction of false alarms associated with false distress orders in supply chain systems, in accordance with various non-limiting example embodiments. Method 1200 commences at 1202 wherein prediction engine 302, in response to detecting one or more suspected false distress order can collect and create a dataset that comprises orders for which the order was labeled as being in good order (e.g., good_order); orders that have been labeled as being in good order are typically those orders that have passed through the entirety of system 1400 without having raised any distress signals.

At act 1204, prediction engine 302 can determine a target variable value. Identified target variable values can be based, for instance, on the actual time taken for an order to transition from a first status to a second status, and/or the identified target variable value can be based on when an order was placed to when the ordered product was finally shipped, depending on what SLA is selected.

At act 1206, prediction engine 302 can perform the acts of data cleaning and/or data pre-processing, wherein categorical variables can be encoded using one or more of one-hot encoding and/or label encoding. As has been observed, label encoding converts categorical variables into numerical representations so that the categorical variables comport with machine learning models that typically only accept numerical data, and one-hot encoding converts categorical variables to groups of bits among which the only permissible combinations of values are those with a single high (1) bit while all the other bits are low (0) bits. Further, the acts of data cleaning and/or pre-processing, at act 1206, can also include appropriately handling missing data.

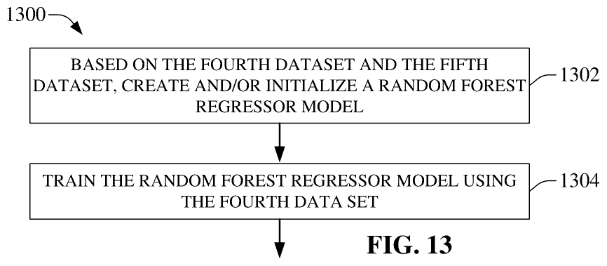

FIG. 13 illustrates a further time-sequence diagram, flow diagram, or method 1300 that can be used, by detection engine 102 and/or prediction engine 202 to facilitate correction of false alarms associated with false distress orders in supply chain systems, in accordance with various non-limiting example embodiments. Method 1300 can commence at act 1302, wherein detection engine 102 and/or prediction engine F2F02 can train a random forest regression model by initializing the model through the use of scikit-learn's RandomForestRegressor. Thereafter, at action 1304, detection engine 102 and/or prediction engine 302 can train the random forest regression model using the fourth dataset (training dataset).

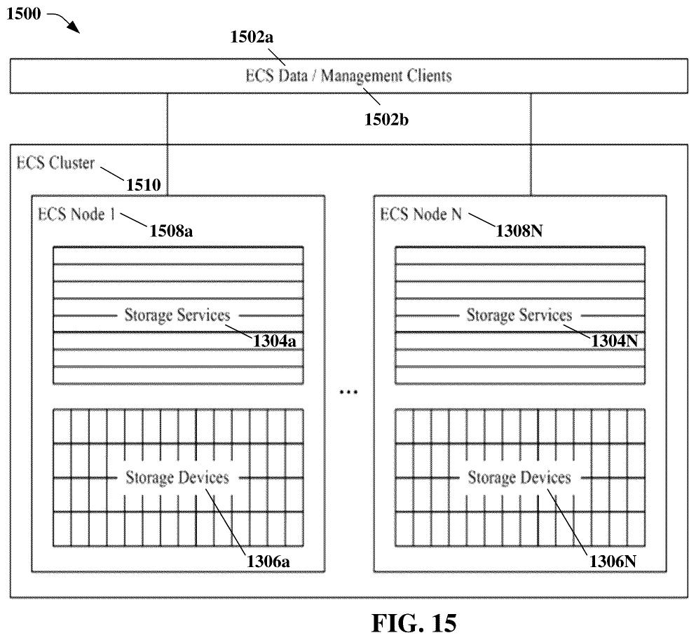

In the following, FIG. 15 describes an example non-limiting cloud storage system in the non-limiting context of an ECS storage system, but for the avoidance of doubt, the subject embodiments can apply to any storage platform. For instance, in this regard, FIG. 15 illustrates an ECS storage system 1500 comprising a cloud-based object storage appliance in which corresponding storage control software comprising, e.g., ECS data client(s) 1502a, ECS management client(s) 1502b, storage service(s) 1504a . . . 1504N, etc. and storage devices 1506a . . . 1506N (e.g., storage media, such as physical magnetic disk media, etc. of respective ECS nodes of ECS cluster 1510) are combined as an integrated system with no access to the storage media other than through the ECS storage system 1500.

In this regard, ECS cluster 1510 comprises multiple nodes 1508a 1508N, storage nodes, ECS nodes, etc. Each node is associated with storage devices 1506a . . . 1506N, e.g., hard drives, physical disk drives, storage media, etc. In embodiment(s), ECS node 1508a, or any ECS node, executing on a hardware appliance can be communicatively coupled, connected, cabled to, etc., e.g., 15 to 120 storage devices. Further, each ECS node can execute one or more services for performing data storage operations described herein.

For instance, the ECS storage system 1500 can be an append-only virtual storage platform that protects content from being erased or overwritten for a specified retention period. In particular, the ECS storage system 1500 does not employ traditional data protection schemes like mirroring or parity protection. Instead, the ECS storage system 1500 utilizes erasure coding for data protection, wherein data, a portion of the data, e.g., a data chunk, is broken into fragments, and expanded and encoded with redundant data pieces and then stored across a set of different locations or storage media, e.g., across different storage nodes.

The ECS storage system 1500 can support storage, manipulation, and/or analysis of unstructured data on a massive scale on commodity hardware. As an example, the ECS storage system 1500 can support mobile, cloud, big data, and/or social networking applications. In another example, the ECS storage system 1500 can be deployed as a turnkey storage appliance, or as a software product that can be installed on a set of qualified commodity servers and disks, e.g., within a node, data storage node, etc. of a cluster, data storage cluster, etc. In this regard, the ECS storage system 1500 can comprise a cloud platform that comprises at least the following features: (i) lower cost than public clouds; (ii) unmatched combination of storage efficiency and data access; (iii) anywhere read/write access with strong consistency that simplifies application development; (iv) no single point of failure to increase availability and performance; (v) universal accessibility that eliminates storage silos and inefficient extract, transform, load (ETL)/data movement processes; etc.

In embodiment(s), the cloud-based data storage system can comprise an object storage system, e.g., a file system comprising, but not limited to comprising, a Dell EMC® Isilon file storage system. As an example, a storage engine can write all object-related data, e.g., user data, metadata, object location data, etc. to logical containers of contiguous disk space, e.g., such containers comprising a group of blocks of fixed size (e.g., 128 MB) known as chunks. Data is stored in the chunks and the chunks can be shared, e.g., one chunk can comprise data fragments of different user objects. Chunk content is modified in append-only mode, e.g., such content being protected from being erased or overwritten for a specified retention period. When a chunk becomes full enough, it is sealed, closed, etc. In this regard, content of a sealed, closed, etc. chunk is immutable, e.g., read-only, and after the chunk is closed, the storage engine performs erasure-coding on the chunk.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As utilized herein, the terms “logic,” “logical,” “logically,” and the like are intended to refer to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

As utilized herein, terms “component,” “system,” “engine”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server, client, etc. and the server, client, etc. can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. In yet another example, a component can be an apparatus that provides specific functionality through electronic components without mechanical parts; the electronic components can comprise one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can comprise, but are not limited to: random access memory (RAM); read only memory (ROM); electrically erasable programmable read only memory (EEPROM); flash memory or other memory technology (e.g., card, stick, key drive, thumb drive, smart card); solid state drive (SSD) or other solid-state storage technology; optical disk storage (e.g., compact disk (CD) read only memory (CD ROM), digital video/versatile disk (DVD), Blu-ray disc); cloud-based (e.g., Internet based) storage; magnetic storage (e.g., magnetic cassettes, magnetic tape, magnetic disk storage or other magnetic storage devices); a virtual device that emulates a storage device and/or any of the above computer-readable media; or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used to determine probabilistic likelihoods that code paths utilize operating system synchronization mechanism, as described herein.

A classifier can be a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to infer an action that a user desires to be automatically performed. In the case of communication systems, for example, attributes can be information received from access points, servers, components of a wireless communication network, etc., and the classes can be categories or areas of interest (e.g., levels of priorities). A support vector machine is an example of a classifier that can be employed. The support vector machine operates by finding a hyper-surface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

In accordance with various aspects of the subject specification, artificial intelligence based systems, components, etc. can employ classifiers that are explicitly trained, e.g., via a generic training data, etc. as well as implicitly trained, e.g., via observing characteristics of communication equipment, e.g., a server, etc., receiving reports from such communication equipment, receiving operator preferences, receiving historical information, receiving extrinsic information, etc. For example, support vector machines can be configured via a learning or training phase within a classifier constructor and feature selection module. Thus, the classifier(s) can be used by an artificial intelligence system to automatically learn and perform a number of functions.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

As it is employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” “data storage,” “database,” “storage medium,” “socket”, and substantially any other information storage component relevant to operation and functionality of a system, component, and/or process, can refer to “memory components,” or entities embodied in a “memory,” or components comprising the memory. It will be appreciated that the memory components described herein can be either volatile memory or nonvolatile memory, or can comprise both volatile and nonvolatile memory.

By way of illustration, and not limitation, nonvolatile memory, for example, can be included in a data storage cluster, non-volatile memory 1622, disk storage 1624, and/or memory storage 1646, further description of which is below. For instance, nonvolatile memory can be included in read only memory (ROM), programmable ROM (PROM), electrically programmable ROM (EPROM), electrically erasable ROM (EEPROM), or flash memory. Volatile memory 1620 can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

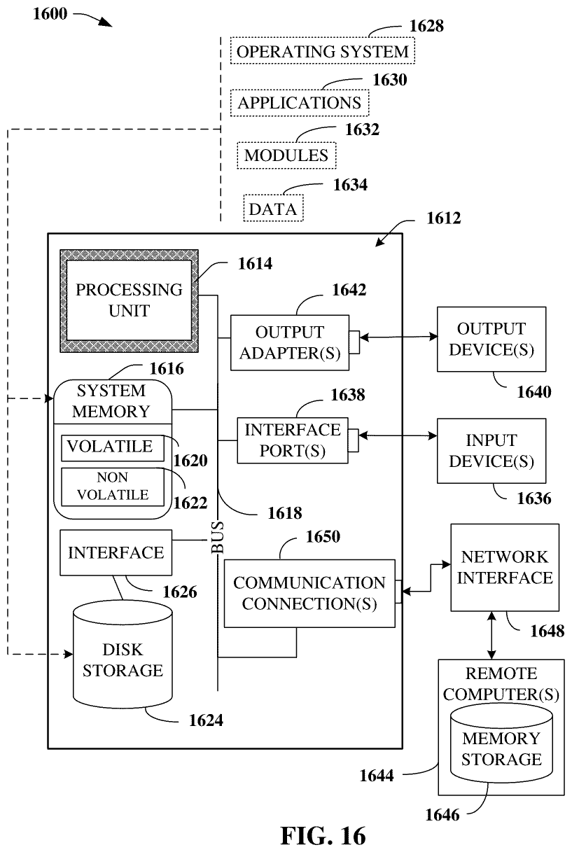

In order to provide a context for the various aspects of the disclosed subject matter, FIG. 16, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that various embodiments disclosed herein can be implemented in combination with other program modules. Generally, program modules comprise routines, programs, components, data structures, etc. that perform particular tasks and/or implement particular abstract data types.

Moreover, those skilled in the art will appreciate that the inventive systems can be practiced with other computer system configurations, comprising single-processor or multiprocessor computer systems, computing devices, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communication network; however, some if not all aspects of the subject disclosure can be practiced on stand-alone computers. In a distributed computing environment, program modules can be located in both local and remote memory storage devices.

With reference to FIG. 16, a block diagram of a computing system 1600, e.g., system 160, operable to execute the disclosed systems and methods is illustrated, in accordance with an embodiment. Computer 1612 comprises a processing unit 1614, a system memory 1616, and a system bus 1618. System bus 1618 couples system components comprising, but not limited to, system memory 1616 to processing unit 1614. Processing unit 1614 can be any of various available processors. Dual microprocessors and other multiprocessor architectures also can be employed as processing unit 1614.

System bus 1618 can be any of several types of bus structure(s) comprising a memory bus or a memory controller, a peripheral bus or an external bus, and/or a local bus using any variety of available bus architectures comprising, but not limited to, industrial standard architecture (ISA), micro-channel architecture (MSA), extended ISA (EISA), intelligent drive electronics (IDE), VESA local bus (VLB), peripheral component interconnect (PCI), card bus, universal serial bus (USB), advanced graphics port (AGP), personal computer memory card international association bus (PCMCIA), Firewire (IEEE 1394), small computer systems interface (SCSI), and/or controller area network (CAN) bus used in vehicles.

System memory 1616 comprises volatile memory 1620 and nonvolatile memory 1622. A basic input/output system (BIOS), containing routines to transfer information between elements within computer 1612, such as during start-up, can be stored in nonvolatile memory 1622. By way of illustration, and not limitation, nonvolatile memory 1622 can comprise ROM, PROM, EPROM, EEPROM, or flash memory. Volatile memory 1620 comprises RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1612 also comprises removable/non-removable, volatile/non-volatile computer storage media. FIG. 16 illustrates, for example, disk storage 1624. Disk storage 1624 comprises, but is not limited to, devices like a magnetic disk drive, floppy disk drive, tape drive, Jaz drive, Zip drive, LS-100 drive, flash memory card, or memory stick. In addition, disk storage 1624 can comprise storage media separately or in combination with other storage media comprising, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1624 to system bus 1618, a removable or non-removable interface is typically used, such as interface 1626.

It is to be appreciated that FIG. 16 describes software that acts as an intermediary between users and computer resources described in suitable operating environment 1600. Such software comprises an operating system 1628. Operating system 1628, which can be stored on disk storage 1624, acts to control and allocate resources of computer system 1612. System applications 1630 take advantage of the management of resources by operating system 1628 through program modules 1632 and program data 1634 stored either in system memory 1616 or on disk storage 1624. It is to be appreciated that the disclosed subject matter can be implemented with various operating systems or combinations of operating systems.

A user can enter commands or information into computer 1612 through input device(s) 1636. Input devices 1636 comprise, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1614 through system bus 1618 via interface port(s) 1638. Interface port(s) 1638 comprise, for example, a serial port, a parallel port, a game port, a universal serial bus (USB), a wireless based port, e.g., Wi-Fi, Bluetooth, etc. Output device(s) 1640 use some of the same type of ports as input device(s) 1636.

Thus, for example, a USB port can be used to provide input to computer 1612 and to output information from computer 1612 to an output device 1640. Output adapter 1642 is provided to illustrate that there are some output devices 1640, like display devices, light projection devices, monitors, speakers, and printers, among other output devices 1640, which use special adapters. Output adapters 1642 comprise, by way of illustration and not limitation, video and sound devices, cards, etc. that provide means of connection between output device 1640 and system bus 1618. It should be noted that other devices and/or systems of devices provide both input and output capabilities such as remote computer(s) 1644.

Computer 1612 can operate in a networked environment using logical connections to one or more remote computers, such as remote computer(s) 1644. Remote computer(s) 1644 can be a personal computer, a server, a router, a network PC, a workstation, a microprocessor based appliance, a peer device, or other common network node and the like, and typically comprises many or all of the elements described relative to computer 1612.

For purposes of brevity, only a memory storage device 1646 is illustrated with remote computer(s) 1644. Remote computer(s) 1644 is logically connected to computer 1612 through a network interface 1648 and then physically and/or wirelessly connected via communication connection 1650. Network interface 1648 encompasses wire and/or wireless communication networks such as local-area networks (LAN) and wide-area networks (WAN). LAN technologies comprise fiber distributed data interface (FDDI), copper distributed data interface (CDDI), Ethernet, token ring and the like. WAN technologies comprise, but are not limited to, point-to-point links, circuit switching networks like integrated services digital networks (ISDN) and variations thereon, packet switching networks, and digital subscriber lines (DSL).

Communication connection(s) 1650 refer(s) to hardware/software employed to connect network interface 1648 to bus 1618. While communication connection 1650 is shown for illustrative clarity inside computer 1612, it can also be external to computer 1612. The hardware/software for connection to network interface 1648 can comprise, for example, internal and external technologies such as modems, comprising regular telephone grade modems, cable modems and DSL modems, wireless modems, ISDN adapters, and Ethernet cards.

The computer 1612 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1612 can connect to other devices/networks by way of antenna, port, network interface adaptor, wireless access point, modem, and/or the like.

The computer 1612 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This comprises at least Wi-Fi and Bluetooth wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect communication devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating there from. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, comprising:
receiving, from a customer device associated with a customer identity, an active order for a manufacture of a product;
based on the active order, a service level agreement associated with the active order, and a defined status identifier appended to the active order, determining that the active order is a suspected false distress order;
based on the suspected false distress order, using a classification model to determine that the suspected false distress order is a false distress order; and
based on determining that the suspected false distress order is the false distress order, using a regression model, the service level agreement appended to the active order, and the defined status identifier appended to the active order, to determine a predicted time value to enter in a record of records associated with the active order, wherein the predicted time value is a prediction, using the regression model, based on a dataset of historical time values associated with the defined status identifier and a previous active order associated with the defined status identifier.

2. The system of claim 1, wherein the classification model, prior to deployment, is trained based on a determined gradient boosting framework.

3. The system of claim 1, wherein the classification model, prior to deployment, is initialized using a group of default parameters.

4. The system of claim 1, wherein the classification model, prior to deployment, is adapted using at least one of a collection of hyper-parameters comprising a number value of boosting stages to be executed in tuning the classification model, a learning rate representing a value at which the classification model adapts over each iteration of the classification model before deployment into a production environment, or a maximum depth value of individual estimators.

5. The system of claim 1, wherein the classification model, prior to deployment, is evaluated using a validation dataset, and wherein evaluation of a performance of the classification model, prior to deployment, is based on a diversity of hyper-parameters.

6. The system of claim 1, wherein the classification model is evaluated using a testing dataset in relation to an accuracy of the classification model, a precision of the classification model, and a confusion matrix.

7. The system of claim 1, wherein the classification model is evaluated based on an analysis of feature importance, and wherein the analysis of the feature importance indicates areas associated with the classification model prior to deployment of the classification model into a production environment to increase a defined performance metric associated with the production environment.

8. A method, comprising:
in response to receiving, by a device comprising at least one processor, an active order for development of a service associated with a product, a service level agreement associated with the active order, and a defined status identifier appended to the active order, determining that the active order is a suspected false distress order;
based on the suspected false distress order, using, by the device, a first model to determine that the suspected false distress order is a false distress order; and
based on determining that the suspected false distress order is the false distress order, using, by the device, a second model, the service level agreement appended to the active order, and the defined status identifier appended to the active order, to determine a predicted time value to enter in a record of records associated with the active order, wherein the predicted time value is a prediction, by the second model, based on a dataset of historical time values associated with the defined status identifier and a previous active order associated with the defined status identifier.

9. The method of claim 8, wherein the second model, before deployment of the second model into a production environment, is developed based on a dataset that comprises previous active order data representing a group of previously active orders associated with a good order flag indicative that the previously active order was not marked as being the suspected false distress order.

10. The method of claim 9, wherein the previous active order data of the group of previously active orders comprises a grouping of features comprising order attributes and processing time values at one or more processing state associated with the defined status identifier appended to the previously active order.

11. The method of claim 8, wherein the second model, before deployment of the second model into a production environment, is developed using a target variable value representative of an actual time for the active order to transition from a first production state to a second production state.

12. The method of claim 8, wherein the second model, before deployment of the second model into a production environment, is developed using a first time value associated with a placement, based on user input associated with a user entity, of a previously active order and a second time value associated with initiating, by the device, the service associated with the product, and the service level agreement associated with the initiating of the service associated with the product.

13. The method of claim 8, wherein the second model, before deployment of the second model into a production environment, is initialized using a random forest regression process.

14. The method of claim 8, wherein the second model, before deployment of the second model into a production environment, is trained using a training dataset comprising a sub-grouping of previous active order data representing previously active orders associated with a good order flag indicative that a previously active order was not marked as being the suspected false distress order.

15. The method of claim 8, wherein the second model, before deployment of the second model into a production environment, is evaluated using a testing dataset comprising a sub-group of previously active order data representing previously active orders associated with a bona fide order flag indicative that the previously active order was not marked as being the suspected false distress order.

16. The method of claim 15, wherein the second model, before deployment of the second model into a production environment, is evaluated using a metric for regression comprising a mean absolute error metric, a mean squared error metric, or a root mean squared error metric.

17. A non-transitory machine-readable medium comprising instructions that, in response to execution, cause a system comprising at least one processor to perform operations, comprising:
in response to receiving an active order for development of a service associated with a product, a service level agreement associated with the active order, and a defined status identifier appended to the active order, determining that the active order is a suspected false distress order;
based on the suspected false distress order, using a first model to determine that the suspected false distress order is a false distress order; and
based on identifying the false distress order, using a second model, the service level agreement appended to the active order, and the defined status identifier appended to the active order, to determine a predicted time value to enter in a record of records associated with the active order, wherein the predicted time value is a prediction, by the second model, based on a dataset of historical time values associated with the defined status identifier and a previous active order associated with the defined status identifier.

18. The non-transitory machine-readable medium of claim 17, wherein the first model prior to deployment is adapted using a collection of hyper-parameters comprising a number value of boosting stages to be executed in tuning the first model, a learning rate representing a value at which the first model adapts over each iteration of the first model before the deployment into a production environment, and a maximum depth value of individual estimators.

19. The non-transitory machine-readable medium of claim 17, wherein the first model, prior to deployment, is evaluated using a validation dataset, and wherein evaluation of performance of the first model prior to the deployment is based on a diversity corresponding to hyper-parameters applicable to the first model.

20. The non-transitory machine-readable medium of claim 17, wherein the first model is evaluated using at least one of a testing dataset in relation to an accuracy of the first model, a precision of the first model, or a confusion matrix.
